(19) United States
(12) Patent Application Publication
(10) Pub. No.: US 2014/0111790 A1
(43) Pub. Date: Apr. 24, 2014

(54) PRETREATMENT METHOD AND APPARATUS

(71) Applicant: SAMSUNG ELECTRO-MECHANICS CO., LTD., Suwon (KR)

(72) Inventors: Eun Jin Choi, Suwon (KR); Sang Phil Lee, Suwon (KR); Se Kyung Lee, Suwon (KR); Seon Young Ahn, Suwon (KR); Yun Hee Kim, Suwon (KR); Suk Jin Ham, Suwon (KR)

(73) Assignee: SAMSUNG ELECTRO-MECHANICS CO., LTD., Suwon (KR)

(21) Appl. No.: 13/848,797

(22) Filed: Mar. 22, 2013

(30) Foreign Application Priority Data
Oct. 19, 2012 (KR) 10-2012-0116699

(51) Int. Cl. G01N 1/38

(52) U.S. Cl. CPC G01N 1/38
USPC 356/36

(57) ABSTRACT

There is provided a method for performing a pretreatment on an unknown sample including: preparing a plurality of different types of first solutions; adding an unknown sample to the plurality of first solutions and determining whether or not the unknown sample is dissolved; selecting one among the plurality of first solutions in which the unknown sample is dissolved; preparing a plurality of second solution by differentiating concentrations of the selected solution; adding an unknown sample to the second solution and determining whether or not the unknown sample is dissolved; selecting a solution having the lowest concentration in which the unknown sample can be dissolved from among the second solutions; and dissolving the unknown sample by using the solution having the lowest concentration.

### CROSS-REFERENCE TO RELATED APPLICATIONS

This application claims the priority of Korean Patent Application No. 10-2012-0116699 filed on Oct. 19, 2012, in the Korean Intellectual Property Office, the disclosure of which is incorporated herein by reference.

### BACKGROUND OF THE INVENTION

1. Field of the Invention

The present invention relates to a pretreatment method and a pretreatment apparatus capable of enhancing accuracy in analyzing an unknown sample.

2. Description of the Related Art

Chemical analysis is used as a method for detecting and checking atoms, molecules, ions, radicals, and the like, constituting a material or determining a relative amount of a particular compound existing in a material. Chemical analysis is divided into qualitative analysis and quantitative analysis. Qualitative analysis is performed to reveal a composition of a compound or check for the presence of a particular compound of a mixture, while quantitative analysis is performed to determine an amount of each compound in a mixture.

Chemical analyses include various methods, and in an analysis, a pretreatment process, as a preceding operation, in which a sample to be analyzed is decomposed by using a particular solvent, must be undertaken.

A pretreatment process generally refers to a process of decomposing a sample by using a solvent, and in this case, the sample is decomposed mainly by using acid.

In the pretreatment process, a sample may be easily decomposed in the case highly concentrated acid is used, but since acid acts as an impurity in the sample, the accuracy of the chemical analysis is degraded.

Thus, a method of performing a pretreatment by determining an optimal pretreatment solution and degree of concentration thereof is required.

### RELATED ART DOCUMENT

(Patent Document 1) Korean Patent No. 10-1062926

### SUMMARY OF THE INVENTION

An aspect of the present invention provides a pretreatment method and a pretreatment apparatus capable of enhancing accuracy in analyzing an unknown sample.

According to an aspect of the present invention, there is provided a method for performing a pretreatment on an unknown sample, including: preparing a plurality of different types of first solutions; adding an unknown sample to the plurality of first solutions and determining whether or not the unknown sample is dissolved; selecting one among the plurality of first solutions in which the unknown sample is dissolved; preparing a plurality of second solutions by differentiating concentrations of the selected solution; adding an unknown sample to the second solution and determining whether or not the unknown sample is dissolved; selecting a solution having the lowest concentration in which the unknown sample can be dissolved from among the second solutions; and dissolving the unknown sample by using the solution having the lowest concentration.

The plurality of first solutions may be aqueous solutions including one or more acids, or may be pure solutions.

The determining of whether or not the unknown sample is dissolved may be performed by measuring turbidity, and the turbidity may be measured by measuring intensity of transmitted light or scattered light with respect to intensity of incident light.

The unknown sample may be non-pulverized powder.

According to another aspect of the present invention, there is provided a method for determining an unknown sample pretreatment solution including: preparing a plurality of different types of first solutions; adding an unknown sample to the plurality of first solutions and determining whether or not the unknown sample is dissolved; selecting one among the plurality of first solutions in which the unknown sample is dissolved; preparing a plurality of second solutions by differentiating concentrations of the selected solution; adding an unknown sample to the second solution and determining whether or not the unknown sample is dissolved; and selecting a solution having the lowest concentration in which the unknown sample can be dissolved from among the second solutions.

The determining of whether or not the unknown sample is dissolved may be performed by measuring turbidity, and the turbidity may be measured by measuring intensity of transmitted light or scattered light with respect to intensity of incident light.

According to another aspect of the present invention, there is provided a pretreatment apparatus for performing a pretreatment on an unknown sample including: a main body providing an internal space; an injection opening disposed on one surface of the main body; a storage unit disposed in the internal space of the main body and having one surface connected to the injection opening; a nozzle disposed on the other surface of the storage unit; a light source disposed in the internal space; and a detection unit disposed on a lower surface of the internal space.

The pretreatment apparatus may further include a heating unit formed on the lower surface of the internal space and spaced apart from the detection unit by a predetermined interval.

The pretreatment apparatus may further include a beam splitter formed to be adjacent to the light source.

The pretreatment apparatus may further include an observation unit formed on one lateral surface of the main body.

The storage unit may be formed of Teflon.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating a pretreatment method for performing a pretreatment on an unknown sample according to an embodiment of the present invention;

FIG. 2 is a perspective view of a pretreatment apparatus for performing a pretreatment on an unknown sample according to an embodiment of the present invention; and

FIG. 3 is a cross-sectional view taken along line A-A′ in FIG. 2.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

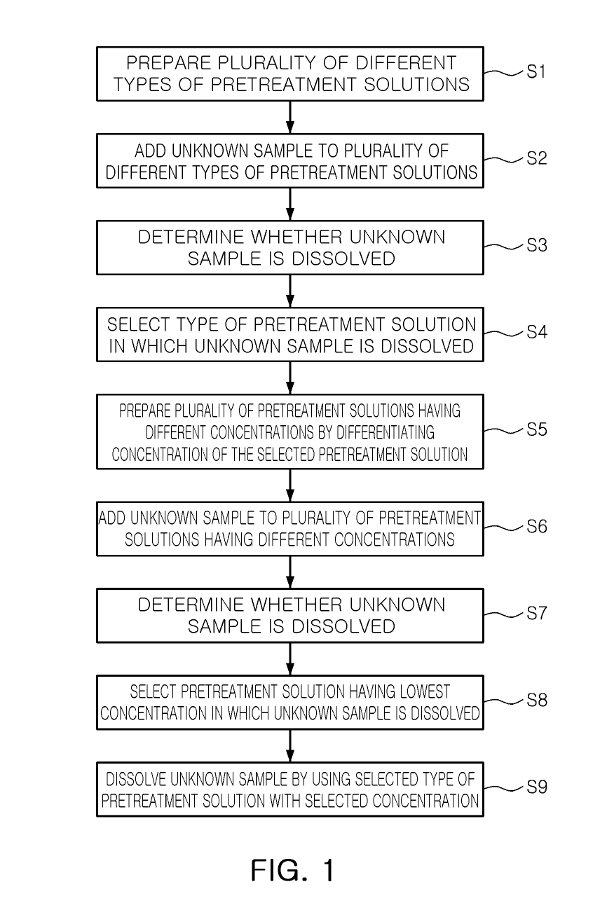

FIG. 1 is a flow chart illustrating a pretreatment method for performing a pretreatment on an unknown sample according to an embodiment of the present invention;

An embodiment of the present invention includes a step of selecting a type of a solution for a pretreatment and a step of selecting a solution concentration.

The step of selecting a type of a solution includes: preparing a plurality of different types of first solutions; adding an unknown sample to the plurality of types of first solutions and determining whether or not the unknown sample is dissolved; and selecting one solution in which the unknown sample is dissolved, from among the first solutions.

The first solutions may be pure or acidic solutions, and the acidic solutions may include one acid or two or more acids, respectively.

Acids included in the acidic solutions may be one or more selected from the group consisting of a nitric acid, a hydrochloric acid, a hydrofluoric acid, a sulfuric acid, and an acetic acid, but the present invention is not limited thereto.

Determining whether or not the unknown sample is dissolved is performed by measuring turbidity of the solution. Turbidity refers to a degree of muddiness of a solution due to suspended solids, and the like, in the solution, and for measurement accuracy, a method of irradiating light, rather than using the naked eye, is used.

In detail, light is made incident to a solution and a degree to which light is scattered by suspended solids is measured optically, to indicate turbidity and there are \textcircled{1}, a method of measuring transmitted light, \textcircled{2}, a method of measuring scattered light, and \textcircled{3}, a method of measuring transmitted and scattered light.

In the case of the method of measuring transmitted light, a light source is irradiated to one side of a solution and a quantity of light transmitted through the solution is measured. An attenuation degree of transmitted light is in inverse proportion to a concentration of suspended solids in the solution. The measurement method is relatively simple and, the intensity of light transmitted through the solution is exponentially reduced as turbidity is increased.

In the case of the method of measuring scattered light, alight source is irradiated to one side of a solution, and light scattered upon being collided with particles in the solution is measured at an angle of 90°. Intensity of the scattered light is increased in proportion to turbidity thereof.

In the case of the method of measuring transmitted and scattered light, a light source is irradiated to one side of a solution and light that has transmitted through the solution and light scattered upon being collided with particles in the solution are measured, and the fact that a ratio of intensities of the two types of light is proportional according to concentration of particles in the solution is used.

Preferably, an unknown sample added to the first solutions is added in the form of a non-pulverized powder to enhance dissolution properties thereof.

The first solutions including the unknown sample may be heated and stirred to increase a dissolution speed.

A solution having the lowest level of turbidity is selected from among the first solutions including the unknown sample, and a type of solution for a pretreatment is determined.

Next, the step of determining a solution concentration for a pretreatment includes preparing a plurality of second solutions by differentiating the solution concentration determined in the step of selecting a type of solution; adding an unknown sample to the second solutions and determining whether or not the unknown sample is dissolved; and selecting a solution having the lowest concentration in which the unknown sample can be dissolved.

In particular, when the concentration of an acid included in the solution used in the pretreatment of the sample is increased, concentration of impurities is increased to lower accuracy in analyzing the unknown sample. Thus, it is important to find a minimum concentration in which the sample is dissolved.

Like the step of determining a type of solution, whether or not the unknown sample is dissolved is determined by measuring turbidity of the solution, and in this case, for accuracy, a method of irradiating light, rather than using the naked eye, is used.

Determining whether or not the unknown sample is dissolved may be performed by measuring turbidity, and here, turbidity may be measured by measuring intensity of transmitted light or scattered light with respect to intensity of incident light. In order to measure turbidity, the method of measuring \textcircled{1}, transmitted light, \textcircled{2}, scattered light, and \textcircled{3}, transmitted and scattered light as mentioned above, may be used, but the present invention is not limited thereto.

The unknown sample added to the second solutions may also have the form of a non-pulverized powder, and after the unknown sample is added, it may be heated and stirred to shorten a dissolution time thereof.

By pre-treating the unknown sample by using the solution determined in the step of selecting a type of solution and in the step of selecting a solution concentration, an impurity concentration in the analysis of the unknown sample can be minimized, and thus, the unknown sample can be accurately analyzed.

Another embodiment of the present invention provides a method for determining an unknown sample pretreatment solution including: preparing a plurality of different types of first solutions; adding an unknown sample to the first solutions and determining whether or not the unknown sample is dissolved; selecting one among the first solutions in which the unknown sample is dissolved; preparing a plurality of second solutions by differentiating concentrations of the selected solution; adding an unknown sample to the second solution and determining whether or not the unknown sample is dissolved; and selecting a solution having the lowest concentration in which the unknown sample can be dissolved from among the second solutions.

The characteristics of the method for determining an unknown sample pretreatment solution are the same as those of the method for performing a pretreatment on an unknown sample according to an embodiment of the present invention as described above, so a description thereof will be omitted.

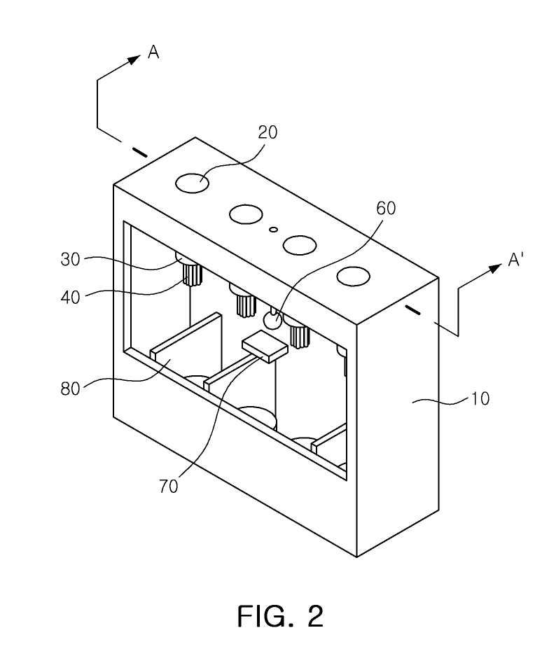

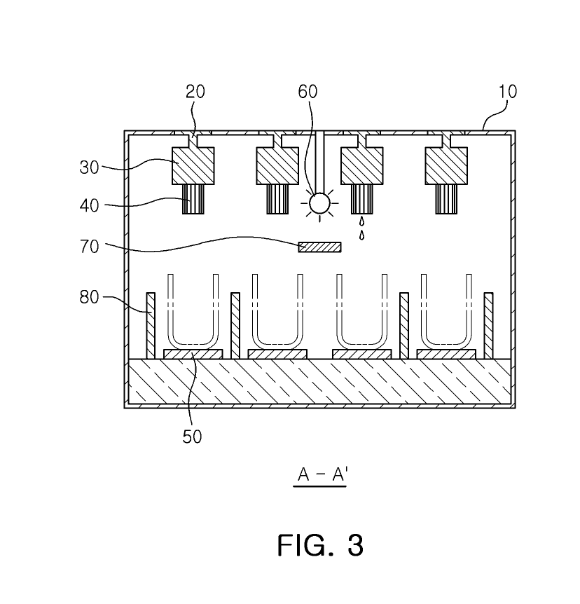

FIGS. 2 and 3 are related to an unknown sample pretreatment apparatus according to another embodiment of the present invention. Specifically, FIG. 2 is a perspective view of the pretreatment apparatus and FIG. 3 is a cross-sectional view taken along line A-A′ of FIG. 2.

Referring to FIGS. 2 and 3, another embodiment of the present invention provides a pretreatment apparatus for performing a pretreatment on an unknown sample including: a main body 10 providing an internal space; an injection opening 20 disposed on one surface of the main body 10; a storage unit 30 disposed in the internal space of the main body 10 and having one surface connected to the injection opening 20; a nozzle 40 disposed on the other surface of the storage unit 30; a light source 60 disposed in the internal space; and a detection unit 80 disposed on a lower surface of the internal space.

Also, the pretreatment apparatus may further include a heating unit 50 formed on the lower surface of the internal space and spaced apart from the detection unit 80 by a predetermined interval.

In addition, the pretreatment apparatus may further include a beam splitter 70 formed to be adjacent to the light source 60, and may further include an observation unit formed on a lateral surface of the main body 10.

The storage unit 30 is a space for accommodating a solution for a pretreatment, and may be formed of Teflon not reacting to an acid (“formed of non-acid reactant Teflon?”). The injection opening 20 is disposed on a surface of the storage unit 30 and configured to allow a solution to be injected into the storage unit 30 therethrough. A plurality of storage units 30 may be formed and injection openings 20 corresponding to the number of storage units may be formed.

The nozzle 40 is disposed on the other surface of the storage unit 30 to discharge a solution accommodated in the storage unit 30. One or more nozzles 40 may be formed in one storage unit 30 in order to adjust a discharge amount of the solution.

A plurality of heating units 50 may be formed in positions corresponding to the nozzles 40, and a beaker may be disposed on an upper surface of the heating unit 50 in order to accommodate the pretreatment solution and the unknown sample.

The beam splitter 70 formed to be adjacent to the light source 60 may appropriately distribute light provided from the single light source 60 such that it reaches the plurality of pretreatment solutions.

Also, the detection unit 80, serving to measure light transmitted through the solution or scatters, namely, transmitted light or scattered light, is formed to be adjacent to the heating unit 50 on which a beaker is disposed. In this case, in order to prevent the detection unit 80 from being damaged by heat from the heating unit 50, preferably, the detection unit 80 and the heating unit 50 are disposed to be spaced apart from one another by a predetermined interval.

In addition, an observation unit may be formed on one surface of the main body 10 in order to check the process as to whether or not the unknown sample is dissolved by the naked eye. The observation unit is formed by replacing a portion of the main body 10 with a transparent material, and in this case, the material may not be particularly limited and any material may be used as long as it allows the interior of the main body 10 to be viewed by the naked eye.

The observation unit may have a form of a door.

As set forth above, according to the embodiments of the present invention, in the case of the pretreatment method and pretreatment apparatus according to embodiments of the invention, accuracy in analyzing an unknown sample can be enhanced.

While the present invention has been shown and described in connection with the embodiments, it will be apparent to those skilled in the art that modifications and variations can be made without departing from the spirit and scope of the invention as defined by the appended claims.

What is claimed is:

1. A method for performing a pretreatment on an unknown sample, the method comprising:
preparing a plurality of different types of first solutions;
adding an unknown sample to the plurality of first solutions and determining whether or not the unknown sample is dissolved;
selecting one among the plurality of first solutions in which the unknown sample is dissolved;
preparing a plurality of second solutions by differentiating concentrations of the selected solution;
adding an unknown sample to the second solution and determining whether or not the unknown sample is dissolved;
selecting a solution having the lowest concentration in which the unknown sample can be dissolved from among the second solutions; and
dissolving the unknown sample by using the solution having the lowest concentration.

2. The method of claim 1, wherein the plurality of first solutions are aqueous solutions including one or more acids, or pure solutions.

3. The method of claim 1, wherein the determining of whether or not the unknown sample is dissolved is performed by measuring turbidity.

4. The method of claim 3, wherein the turbidity is measured by measuring intensity of transmitted light or scattered light with respect to intensity of incident light.

5. The method of claim 1, wherein the unknown sample is non-pulverized powder.

6. A method for determining an unknown sample pretreatment solution, the method comprising:
preparing a plurality of different types of first solutions;
adding an unknown sample to the plurality of first solutions and determining whether or not the unknown sample is dissolved;
selecting one among the plurality of first solutions in which the unknown sample is dissolved;
preparing a plurality of second solutions by differentiating concentrations of the selected solution;
adding an unknown sample to the second solution and determining whether or not the unknown sample is dissolved; and
selecting a solution having the lowest concentration in which the unknown sample can be dissolved from among the second solutions.

7. The method of claim 6, wherein the determining of whether or not the unknown sample is dissolved is performed by measuring turbidity.

8. The method of claim 7, wherein the turbidity is measured by measuring intensity of transmitted light or scattered light with respect to intensity of incident light.

9. A pretreatment apparatus for performing a pretreatment on an unknown sample, the apparatus comprising:
a main body providing an internal space;
an injection opening disposed on one surface of the main body;
a storage unit disposed in the internal space of the main body and having one surface connected to the injection opening;
a nozzle disposed on the other surface of the storage unit;
a light source disposed in the internal space; and
a detection unit disposed on a lower surface of the internal space.

10. The pretreatment apparatus of claim 9, further comprising a heating unit formed on the lower surface of the internal space and spaced apart from the detection unit by a predetermined interval.

11. The pretreatment apparatus of claim 9, further comprising a beam splitter formed to be adjacent to the light source.

12. The pretreatment apparatus of claim 9, further comprising an observation unit formed on one lateral surface of the main body.

13. The pretreatment apparatus of claim 9, wherein the storage unit is formed of Teflon.
